(19) United States
(12) Patent Application Publication
(10) Pub. No.: US 2013/0025632 A1
(43) Pub. Date: Jan. 31, 2013

(54) SLURRY GENERATION

(71) Applicant: Gregory John Hatton, Houston, TX (US)

(72) Inventor: Gregory John Hatton, Houston, TX (US)

(21) Appl. No.: 13/640,493

(22) PCT Filed: Apr. 12, 2011
(86) PCT No.: PCT/US11/32096

§ 371 Date: Oct. 11, 2012

Related U.S. Application Data
(60) Provisional application No. 61/324,148, filed on Apr. 14, 2010.

(51) Int. Cl. B08B 9/04

(52) U.S. Cl. 134/8; 15/104.062

(57) ABSTRACT

A system for maintaining production flow in a subsea pipeline having a proximate and a distal end, the pipeline being in fluid communication with a production facility on a distal end, the system comprising a flow loop comprising an inlet in fluid communication with at least one subsea well adapted to receive a hydrocarbon production flow, and an outlet in fluid communication with the proximate end of the pipeline; a pig launching system, adapted so that a pig may be selectively placed into the flow loop inlet; and a pig receiving system, adapted so that a pig may be removed from the hydrocarbon production flow from the flow loop outlet; wherein the flow loop has an inner surface roughness less than about 1000 micro-inches.

### BACKGROUND OF INVENTION

1. Field of the Invention

This invention is directed to a subsea slurry generation system.

2. Background Art

U.S. Pat. No. 7,530,398 discloses a system for assuring subsea hydrocarbon production flow in pipelines by chilling the hydrocarbon production flow in a heat exchanger and causing solids to form, periodically removing deposits and placing them in a slurry utilizing a closed loop pig launching and receiving systems. U.S. Pat. No. 7,530,398 is herein incorporated by reference in its entirety.

U.S. Patent Application Publication Number 2009/0020288 discloses a system for assuring subsea hydrocarbon production flow in pipelines by chilling the hydrocarbon production flow in a heat exchanger and causing solids to form, periodically removing deposits and placing them in a slurry utilizing a closed loop pig launching and receiving systems. U.S. Patent Application Publication Number 2009/0020288 is herein incorporated by reference in its entirety.

U.S. Patent Application Publication Number 2006/0186023 discloses a method of transporting a produced fluid through a pipe while limiting deposits at a desired pipe inner-wall location comprising providing a pipe having an inner surface roughness Ra less than 2.5 micrometers at said desired pipe inner-wall location, forcing the produced fluid through the pipe, wherein the produced fluid has a wall shear stress of at least 1 dyne per centimeter squared at said desired pipe inner-wall location. U.S. Patent Application Publication Number 2006/0186023 is herein incorporated by reference in its entirety.

### SUMMARY OF INVENTION

One aspect of the invention provides a system for maintaining production flow in a subsea pipeline having a proximate and a distal end, the pipeline being in fluid communication with a production facility on a distal end, the system comprising a flow loop comprising an inlet in fluid communication with at least one subsea well adapted to receive a hydrocarbon production flow, and an outlet in fluid communication with the proximate end of the pipeline; a pig launching system, adapted so that a pig may be selectively placed into the flow loop inlet; and a pig receiving system, adapted so that a pig may be removed from the hydrocarbon production flow from the flow loop outlet; wherein the flow loop has an inner surface roughness less than about 1000 micro-inches.

Advantages of the invention include one or more of the following:

A cold flow loop that produces a slurry flow with smaller particles, more dispersed particles, and/or better flowability.

A cold flow loop that has less solids buildup on an inner wall of the loop, such as less wax, hydrates, and/or other solids.

A pigging system that allows pigging of wall deposits without the usual increase in resistance to pig travel with distance as the pigged material agglomerates in front of the pig.

A pigging system that requires less differential pressure over the length of the flow-line during a pigging operation.

### BRIEF DESCRIPTION OF DRAWINGS

FIG. 1 illustrates an offshore system in accordance with the embodiments of the present disclosure.

FIG. 2A shows a simple schematic of a subsea conduit in accordance with an embodiment of the present disclosure.

FIG. 2B shows a detail cross-section view of a subsea conduit in accordance with an embodiment of the present disclosure.

FIG. 3 shows a simple schematic of a long downstream conduit or flow line in accordance with an embodiment of the present disclosure.

FIG. 4 shows a graph displaying pressure differential across a conventional pig for consecutive runs in accordance with an embodiment of the present disclosure.

FIG. 5 shows a graph displaying pressure differential across a bypass pig for various inner wall average roughness values in accordance with an embodiment of the present disclosure.

### DETAILED DESCRIPTION

In one aspect, embodiments disclosed herein relate generally to apparatuses and methods for transporting hydrocarbons. Specifically, embodiments disclosed herein relate to a system for cooling a production stream to create a slurry prior to transporting the production stream to a production system (e.g., an offshore rig, a facility on the shore). As used herein, ‘production stream’ refers to a stream of hydrocarbons containing water or brine, gas, oil, together with dissolved solids such as waxes, asphaltenes, organic and inorganic salts, and/or other small particles that are extracted from a wellbore during production.

Embodiments disclosed herein further relate to a system for more effective removal of deposits from a heat exchanger or a chilling loop in a subsea, cold flow assurance system. Additionally, embodiments disclosed herein relate to a system for producing a more suitable slurry for transport through a downstream flow line or conduit. Embodiments disclosed herein also relate to a system to remediate deposits in the downstream flow line or conduit.

Hydrocarbons are extracted from wellbores that are located in various environments having varying temperatures and pressures. These environments include a subsea environment, where wellbores are located at the bottom of the sea, up to thousands of feet below the surface of the ocean. In the subsea environment, the temperature of the ocean water that surrounds the wellbores may be lower than the temperature inside the wellbore. A cold flow process system may be used to transport the production stream from the wellbore to the production system. A cold flow process system is a subsea system that may lower the temperature of the production stream to approximately the same temperature as the surrounding deep sea-water. During operation, the production stream flows out of the wellbore and into a subsea conduit that acts as a heat exchanger (e.g., a chilling loop). The subsea conduit may be exposed to the ocean water, which may cause the temperature of the production stream to decrease. Additionally, the chilling loop may be a jacketed counter-flow heat exchanger or any other type of heat exchanger known in the art. As a result of the decrease in temperature of the production stream, dissolved solids may precipitate and new solids may form within the production stream. Further, while solids precipitate and hydrates form, the solid deposits may become adhered to the inner wall of the subsea conduit, constricting flow and possibly blocking the conduit. The partial and/or complete blockage of the conduit may stop production and/or decrease efficiency of the operation.

In certain instances, solid particles flowing through conduit or lines are not necessarily a problem. If the particles do not deposit on walls or equipment, and do not have a large impact on flow characteristics, they may simply flow with the rest of the fluids, as a slurry, without creating a problem situation. Thus, it is desired to achieve a situation where solids precipitate and hydrates form in a controlled manner where solids deposited on the walls may be easily removed with little impact on production. In addition, it is desired to transport the solids with the rest of the production stream in the form of a slurry to a production system by means of a downstream conduit or flow line. Accordingly, a system that may control the precipitation of solids and formation of hydrates, while controlling deposit formation on the walls prior to and during transporting a production stream from a wellbore to a production system is described below.

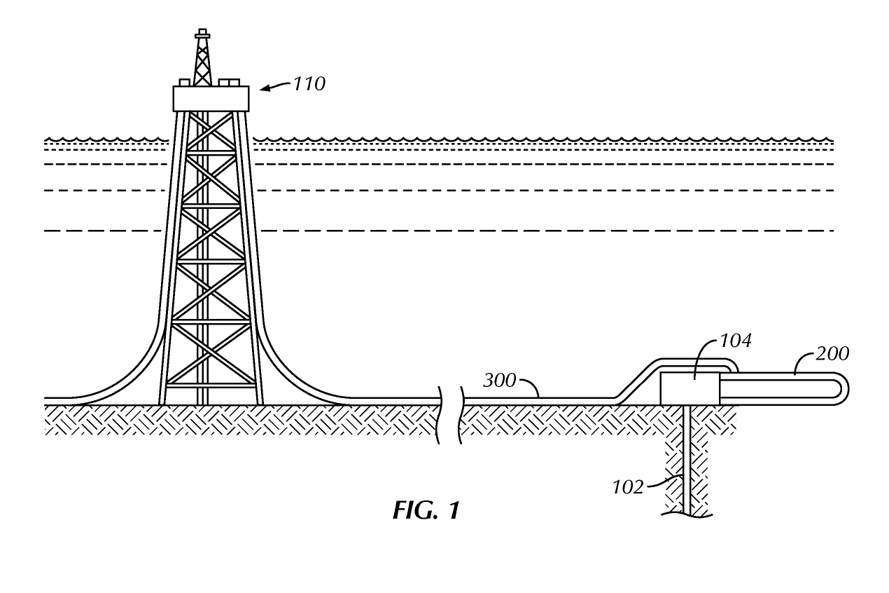

FIG. 1:

FIG. 1 shows a production stream transport system in accordance with embodiments of the present disclosure. A subsea well 102 is shown in the production stage. The wellhead and/or blowout preventer assembly 104 is connected to the well 102. The wellhead and/or blowout preventer assembly 104, as illustrated in FIG. 1, also includes all necessary equipment such as piping, valves, connectors, sensors, etc. needed to safely operate a well. Those of ordinary skill in the art will appreciate that additional components may be present in the wellhead and/or blowout preventer assembly 104 and that multiple wells may be comingled at a manifold. The production stream outlet of the wellhead and/or blowout preventer assembly and/or manifold 104 may connect to a subsea conduit 200. The production stream temperature may change and approach the temperature of the ambient deep sea-water as the production stream flows through the subsea conduit 200. The production stream may flow in the form of a slurry from the subsea conduit 200 to a downstream conduit or flow line 300 that transports the production stream to the production system 110. The production system 110 is shown as an offshore rig in FIG. 1; however, those of ordinary skill in the art will appreciate that it may be any production stream receiving facility, for example, a land based facility or a floating facility such as a spar, semi-sub, TLP, or FPSO vessel.

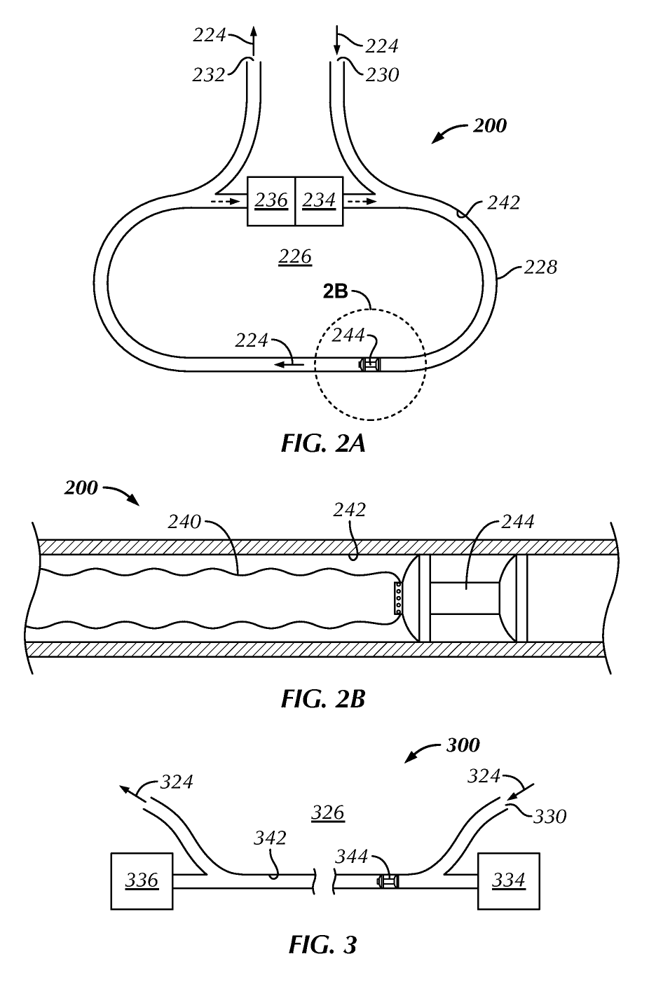

FIGS. 2A & 2B:

FIG. 2A shows one embodiment of a subsea conduit 200. The subsea conduit 200 is a component of a cold flow assurance system, or cold flow process system. The subsea conduit 200 acts as a heat exchanger to cool the production stream 224 to approach the temperature of the ambient deep sea-water 226. The subsea conduit 200 may be a bare-pipe heat exchanger, jacketed counter-flow heat exchanger, or any other heat exchanger known in the art. The composition, pressure, and temperature of production stream 224 coming from the well and entering the subsea conduit 200 may be identified prior to design and construction of the subsea conduit 200. Ambient deep sea-water 226 may be similarly analyzed. Thermal-hydraulic models such as those implemented in commercial software, for example OLGA and UNISIM, which are known in the art may be used to predict the production stream 224 response to chilling conditions at any point within the systems disclosed herein, but thermal-hydraulic models may be used particularly for the design of the subsea conduit 200. The predictions of the thermal-hydraulic models may be used, for example, to determine the necessary size and geometry of the subsea conduit 200. The design of the subsea conduit 200 may be based on factors including, but not limited to, ambient deep sea-water 226 temperature, production stream 224 temperature and pressure, production stream 224 composition, precipitation and hydrate forming temperatures and pressures, and thermal and mechanical properties of the subsea conduit 200 structure. In the case where the subsea conduit 200 is a jacketed counter-flow heat exchanger, the properties of the cooling liquid and structure containing the liquid may also be considered. Specifications that may be determined based on the factors above include heat exchange surface area, flow rates, length of conduit, cross-sectional area of conduit, and materials. The thermal and mechanical properties of the subsea conduit 200 structure are based, in part, on the material used. This material may be a dependent or independent variable. For example, the material may be chosen based on factors such as corrosion resistance, cost, and availability which may make it independent of the design factors above.

The subsea conduit 200 is designed to cool the production stream 224 to the deep sea-water ambient temperature as disclosed herein. Those of ordinary skill in the art will appreciate that an acceptable temperature may be higher or lower than the deep sea-water 226 temperature. For example, a bare-pipe heat exchanger will have an asymptotic temperature change with respect to the ambient deep sea-water 226 temperature. Therefore, an acceptable temperature value may be a determined value, a range, or a percentage of error above the deep sea-water temperature. These acceptable values may be based on precipitation and hydrate forming temperatures or size limits for the subsea conduit.

The subsea conduit 200 shown in FIG. 2A is one embodiment disclosed herein and may be referred to more specifically as a chilling loop. The subsea conduit 200 of FIG. 2A may be a bare-pipe heat exchanger in which the production stream 224 inside the subsea conduit 200 is exposed to the ambient deep sea-water 226 via a conduit wall 228. Preferably the subsea conduit 200 is made of metal. The subsea conduit 200 may be fabricated from standard subsea equipment, or alternatively, the conduit may be specifically designed and fabricated for the application of the system disclosed herein. The production stream 224 enters the subsea conduit 200 through the production stream inlet 230. The production stream 224 may be at a higher temperature than the ambient deep sea-water 226. The production stream 224 may also be under pressure. Preferably, the production stream 224 exits the outlet of the wellhead and/or blowout preventer assembly and enters the subsea conduit via the production stream inlet 230 with minimal heat loss, so as to avoid precipitation of solids and formation of hydrates in the conduits, valves, and other equipment of the systems prior to the subsea conduit 200.

After the production stream 224 enters the subsea conduit 200 through the production stream inlet 230, the production stream 224 flows through the subsea conduit 200. The production stream 224 temperature may approach the ambient deep sea-water 226 temperature as it flows through subsea conduit 200. The production stream 224 may exit the subsea conduit 200 via the production stream outlet 232. The production stream 224 exiting the subsea conduit 200 may be substantially different than the production stream 224 entering. For example, the production stream 224 exiting the subsea conduit 200 may be lower temperature, higher viscosity, and include more solid particles than the production stream 224 entering the subsea conduit 200. The production stream 224 exiting the subsea conduit 200 may be a slurry suitable for transport through a long downstream conduit or flow line and at approximately the same temperature as the ambient deep sea-water 226. A suitable slurry is capable of flowing through the downstream conduit or flow line 300 (FIG. 1) leaving little to no deposits on the inner wall surface of the downstream conduit 300.

As shown in FIG. 2B, solid deposits 240 may form on an inner wall surface 242 of the subsea conduit 200. The solid deposits 240 that adhere to the inner wall surface 242 may include inorganic salts, asphaltenes, waxes, and hydrates. The solid deposits 240 on the inner wall surface 242 may decrease flow, decrease thermodynamic efficiencies, and may cause complete blockage of the subsea conduit 200.

A pig 244 may be used to remove the solid deposits 240 adhered to the inner wall surfaces 242 of the subsea conduit 200. A pig 244 is a device located and moved within a conduit to clean an inner wall surface and to clear partial and/or complete blockages using the pressure of the fluid. The pig may include sensors and equipment to perform additional tasks such as conduit inspection and repair. A pig may have dimensions and shape configured to correspond to the conduit to be cleaned, allowing a maximum cleaning action on the inner wall. Additionally, a pig may be designed for the specific application based on the composition of a production stream, temperatures and pressures of a production stream, and the desired tasks for the pig to perform.

In the embodiment shown in FIG. 2B, the pig is more specifically a bypass pig. A bypass pig allows some fluid to bypass, or flow through, the pig helping to remediate issues of accumulation or agglomeration of solids in front of the pig. Specifically, a bypass pig may prevent pigged deposits from agglomerating and creating a slug that fills the cross-sectional area of the conduit directly in front of the pig. A solid deposit agglomerate in front of a pig may, for example, increase drag, increase pressure, and slow production. The bypass pig may reduce the pressure drop upstream of a pig and improve cleaning of the inner wall of the subsea conduit. More importantly, the fluid of the production stream that flows through the pig helps to create a suitable slurry by mixing the solid deposits removed from inner wall surfaces of the conduit with the fluid of the production stream. The bypass pig may additionally aid in producing a suitable slurry by preventing a solid agglomeration in front of the pig from forming. Even if standard conduit, with standard wall roughness, is used for the subsea conduit, using a bypass-pig pigging system to remove deposits from the subsea conduit reduces the deposition rate and flow assurance upset in the downstream conduit or flow line 300 (FIG. 1). Thus, the production stream delivered to the flow line or conduit downstream of the subsea conduit is more easily flowed and less likely to deposit on the inner wall surfaces.

Referring back to FIG. 2A, a pig launcher 234 and a pig receiver 236 in accordance with embodiments disclosed herein is shown. The pig launcher 234 and pig receiver 236 may be one unit as illustrated in FIG. 2A. In an alternative embodiment, the pig receiver 234 and pig launcher 236 may be two separate units. The pig launcher 234 and/or pig receiver 236 may be simple in design using valves, conduit, and the flow of the production stream to redirect the pig in/out of the production stream of the subsea conduit 200. Alternatively, the pig launcher 234 and/or pig receiver 236 may use pumps and/or other mechanisms to move the pig 244. Preferably the pig launcher 234 and pig receiver 236 operate remotely by electric or hydraulic signal. The pig launcher 234 may be located at or proximate to the production stream inlet 230 of the subsea conduit 200, and the pig receiver 236 may be located at or proximate the production stream outlet 232 of the subsea conduit 200. The pig 244 may stay in the subsea conduit 200, e.g. a chilling loop, and activate either at set time intervals or when a change in pressure is detected. A change in pressure may indicate partial or complete clogging of the conduit due to deposit buildup.

In one embodiment, the inner wall surface 242 of the subsea conduit 200 has an average roughness of 1000 micro-inches or less, for example less than 500, or less than 250 micro-inches. Standard conduit used in subsea applications typically has an average roughness of 1800 micro-inches (450 micro-meters). In accordance with embodiments disclosed herein, conduit with an inner wall average roughness of 1000 micro-inches (25 micro-meters) or less may be used. To form a conduit with an average roughness of 1000 micro-inches or less, a standard conduit with an approximate average roughness of 1800 micro-inches may undergo special mill processing or a finishing process (e.g., polishing). Advantageously, pigging a conduit with an average roughness of 1000 micro-inches or less, in accordance with embodiments disclosed herein, may result in fewer residual solid deposits on the inner wall surface than pigging a standard conduit with an approximate average roughness of 1800 micro-inches. The inner wall of the conduit with an average roughness of 1000 micro-inches or less may be cleaned more completely and improve the removal of deposits by pigging. The deposits removed may be smaller particulates, thus creating a more suitable slurry. Fewer residual solid deposits after pigging, provides better thermodynamic properties of the conduit. For example, even a thin layer of wax may act as an insulator and greatly decrease the thermodynamic efficiency of a heat exchanger. Those of ordinary skill in the art will appreciated that other solid deposits may have similar thermodynamic effects as wax.

In one embodiment, a suitable slurry may be formed using a bypass pig in combination with a subsea conduit having an inner wall average roughness of less than 1000 micro-inches. Given a bypass pig with proper shape, dimensions, and fluid flow, in this embodiment, the bypass pig may produce a slurry with smaller particulates. A slurry with small particulates is less prone to causing flow assurance upsets in the downstream conduit or flow line. A properly designed bypass pig, for example, may allow the correct amount of the production stream to flow through the pig so that a desired pressure difference is achieved across the pig. Additionally, the amount of production stream flow through the pig may be designed based on the amount of dissolved solids and/or deposits on the inner wall in order to provide a suitable mixture for the slurry. A properly designed bypass pig may also have dimensions and shape configured for the given conduit, providing sufficient cleaning action on the inner wall.

In one embodiment, a suitable pig may include one or more of the following characteristics:

1) incorporates a passage for bypass flow through the center of the pig 244,

2) is designed such that the bypass flow liquid-volumetric rate is roughly ten (10) times the volumetric rate of the solids (deposits) pigged from the wall,

3) may be constructed with a body composed of materials used in standard scrapper pigs (e.g., polyurethane) and a bypass composed of standard elements used in the oil and gas industry for flow (e.g., rigid or flexible tubing with an orifice), and/or

4) has an outer diameter a little greater than the pipe inner diameter as is common for scraper pigs.

FIG. 3:

FIG. 3 shows a downstream conduit or flow line 300 in accordance with embodiments disclosed herein. The production stream 324 flows from the outlet of the subsea conduit to the production stream inlet 330 of the downstream conduit or flow line 300. The production stream 324 entering the production stream inlet 330 may be a suitable slurry to flow through the downstream conduit or flow line 300 with minimum deposition buildup or flow assurance upsets. The production stream 324 may also be approximately the same temperature as the ambient deep sea-water 326.

In one embodiment, the downstream conduit or flow line 300 may be equipped with a pigging system. The pigging system includes a pig launcher 334 and a pig receiver 336. While the suitable slurry greatly reduces deposition buildup, the pigging system may be used for routine cleaning to ensure proper flow over time. Pig 344 may be any pig known in the art, or preferably a bypass pig. A pig, and particularly a bypass pig, in the downstream conduit or flow line 300 may have a similar design, provide similar performance, and provide similar advantages to a pig in the subsea conduit described above. For example, the pig 344 may clean the inner wall surface 342 preventing partial or complete blockages that disrupt the flow of production stream 324 through the downstream conduit or flow line 300. Furthermore, a bypass pig may help to remediate issues of accumulation or agglomeration of solid deposits in front of the pig. The bypass pig may reduce the pressure drop upstream of the pig and improve cleaning of the inner wall of the subsea conduit. Even if standard conduit, with standard wall roughness, is used for the subsea conduit, using a bypass-pig pigging system to remove deposits from the subsea conduit reduces the deposition rate and flow assurance upset.

One embodiment disclosed herein discloses an inner wall surface 342 of the downstream conduit or flow line 300 that has an average roughness of 1000 micro-inches (25 micro-meters) or less. Standard conduit used in subsea applications typically has an average roughness of 1800 micro-inches (450 micro-meters). As previously discussed with respect to FIGS. 2A and 2B, to form a conduit with an average roughness of 1000 micro-inches or less, a standard conduit with an approximate average roughness of 1800 micro-inches may undergo a finishing process (e.g., polishing). A downstream conduit or flow line 300 having an average roughness of 1000 micro-inches or less may provide similar performance and advantages as a subsea conduit described above having an average roughness of 1000 micro-inches or less. For example, pigging a conduit with an average roughness of 1000 micro-inches or less results in fewer residual solid deposits on the inner wall surface than pigging a standard conduit with an approximate average roughness of 1800 micro-inches. A pig, e.g. a bypass pig, may remove deposits on the inner wall surface with an average roughness of 1000 micro-inches or less more effectively. The removed deposits may also be smaller particles.

### EXAMPLES

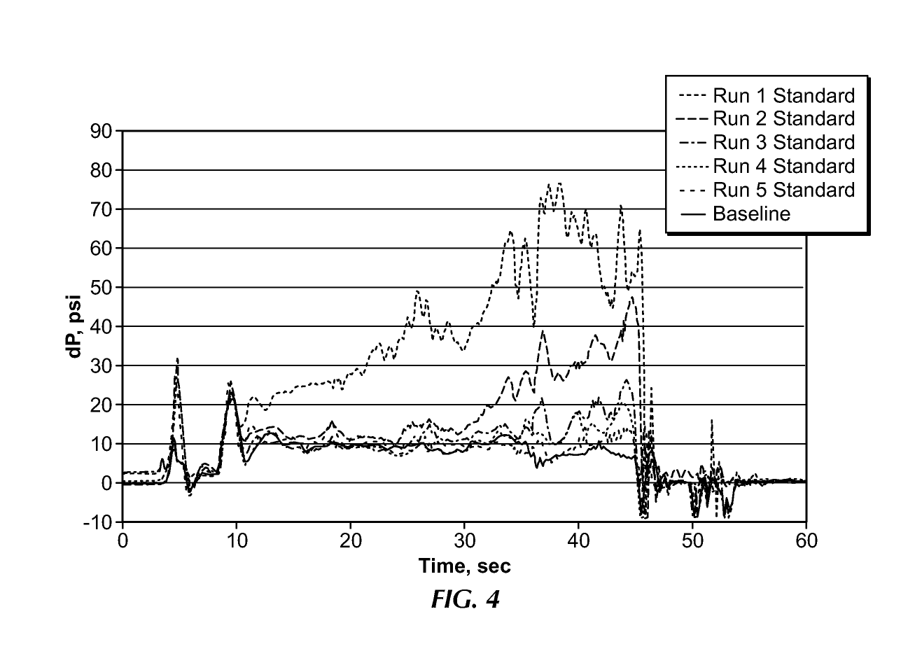

FIG. 4:

FIG. 4 shows data from pigging a subsea conduit, more specifically a chilling loop, with a standard pig. The chilling loop is fabricated from standard conduit used in subsea flow line applications, which has a roughness of approximately 1800-micro-inches (450-micro-meters). The horizontal axis of FIG. 4 is time in seconds. During the experiment, the standard pig is launched at a time near 10-s on the time scale. With time, the pig moves through the conduit until it reaches the pig receiver at a time near 46-s. The differential pressure across the pigging system conduit during the test (dP) is shown on the vertical axis in pounds per square inch. The data shown in FIG. 4 is for pigging runs following a period of time during which wax was naturally deposited on the conduit inner wall. The wax was deposited while a Gulf of Mexico crude oil was cooled as it flowed through the conduit. The temperature of the crude oil at the inlet to the conduit section was maintained at a constant temperature and the conduit outer wall was cooled by counter-flowing coolant at a temperature below the wax deposition temperature. During pigging run 1, “Run 1 Standard,” the differential pressure across the pigging system increases with time as the pig moves through the conduit. The greater the time, the greater the distance the pig has progressed down the conduit and the greater the amount of wax scraped from the conduit inner wall. The pressure increase with pig movement down the conduit is a result of the growth in pigged wax volume accumulated during the movement. The pigged wax agglomerates ahead of the pig and resists movement Immediately following “Run 1 Standard,” a second pigging run “Run 2 Standard” was performed. The second pigging run “Run 2 Standard” was followed by a third run “Run 3 Standard.” The third pigging run “Run 3 Standard” was followed by a forth run “Run 4 Standard,” which was followed by a fifth pigging run “Run 5 Standard.” The baseline curve is the differential pressure during a pigging run without any wax deposits on the conduit wall. Heat exchangers one hundred times longer (or more) than the test conduit in this experiment may be used for the cold flow process in a subsea application.

Runs 1 and 2 show that differential pressure across the pig increases as the wax accumulates. Runs 3-5 additionally show accumulation over time and distance; however, the accumulation is to a lesser extent because most of the deposits were removed in Runs 1 and 2. Runs 1-5 all have higher differential pressures at the end of each run than the Baseline run. This shows that although much of the wax had been removed, there was still some accumulation that increased pressure.

The results of this experiment illustrate a need for using a bypass pigging system, which may reduce differential pressure by reducing agglomerations of deposits in front of the pig. A bypass pig may create a slurry which creates less drag than an agglomeration of deposits in front of a standard pig. The slurry may flow easier through the conduit as a result of less drag.

In a separate experiment, having the same setup as the experiment of FIG. 4, the conduit was opened following the pigging runs so that the conduit inner wall surface could be inspected. These inspections confirm the conclusions drawn from the graph in FIG. 4 that pigging standard conduit with standard pigs does not remove all of the deposits on the inner wall, but rather leaves a thin layer of wax. This level of cleaning is adequate for normal pigging operations as these are only intended to clear sufficient wax to prevent complete blockage of the conduit rather than to return the heat transfer properties of the conduit to that of a deposit free conduit. The data of these pigging runs with standard conduit and standard pig show that this type of pigging system does not recondition the subsea conduit to a deposit-free performance level.

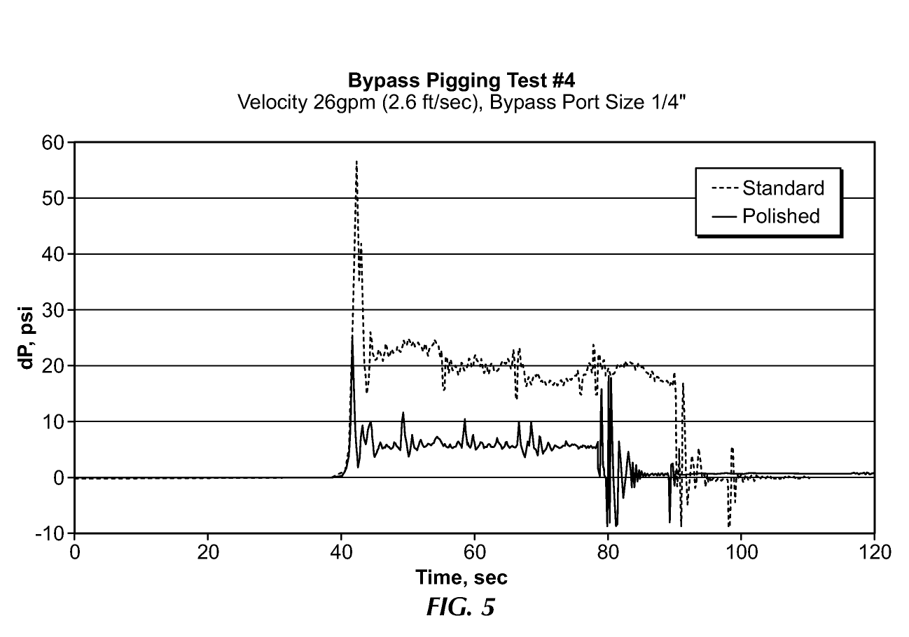

FIG. 5:

FIG. 5 shows the pressure differential across a bypass pig during a pigging run. For both standard conduit, labeled “Standard,” and conduit with a roughness less than 1000-miro-inches, labeled “Polished,” the pressure differential across the conduit with a bypass pig does not show the pressure differential buildup that occurs with a standard pig (FIG. 4), because the pigged deposits do not agglomerate in a slug filling the cross-sectional shape directly in front of the pig. Therefore, the production stream delivered to the flow line or conduit downstream of the subsea conduit is more easily flowed and less likely to leave deposits. Additionally, a significant decrease can be seen in the mean pressure. In this example, the polished conduit has a mean pressure differential across the pig that is approximately one quarter of the mean pressure differential of the standard conduit. This may allow higher production, as there is less restriction in the conduit.

### Illustrative Embodiments

In one embodiment, there is disclosed a system for maintaining production flow in a subsea pipeline having a proximate and a distal end, the pipeline being in fluid communication with a production facility on a distal end, the system comprising a flow loop comprising an inlet in fluid communication with at least one subsea well adapted to receive a hydrocarbon production flow, and an outlet in fluid communication with the proximate end of the pipeline; a pig launching system, adapted so that a pig may be selectively placed into the flow loop inlet; and a pig receiving system, adapted so that a pig may be removed from the hydrocarbon production flow from the flow loop outlet; wherein the flow loop has an inner surface roughness less than about 1000 micro-inches. In some embodiments, the system also includes a bypass pig within the flow loop. In some embodiments, the flow loop is exposed to a subsea environment to provide for cooling of the hydrocarbon production flow approaching a temperature of the subsea environment. In some embodiments, the system also includes a bypass fluid conduit between the flow loop inlet and the proximate end of the pipeline. In some embodiments, the flow loop comprises a forced coolant pipe-in-pipe system, having inner and outer pipes, adapted so that production flows through the inner pipe and coolant flows through the annulus formed between the inner and outer pipes in a direction counter to the production flow direction. In some embodiments, the coolant is seawater. In some embodiments, the pipeline has an inner surface roughness less than about 1000 micro-inches. In some embodiments, the pipeline further comprises one or more bypass pigs.

In one embodiment, there is disclosed a method for maintaining production flow in a subsea pipeline, comprising producing a hydrocarbon from at least one subsea well; transporting the hydrocarbon from the at least one subsea well to a heat exchanger; passing the hydrocarbon through the heat exchanger, in order to cool the hydrocarbon and precipitate at least one solid selected from waxes, paraffins, asphaltenes, and/or hydrates; passing the hydrocarbon through a pipeline from the heat exchanger to a host; and pigging the heat exchanger with a pig to produce a slurry of the solids in the hydrocarbon; wherein the heat exchanger comprises a pipe having an inner surface roughness less than about 1000 micro-inches. In some embodiments, the pig comprises a bypass pig. In some embodiments, the pig is recovered from an outlet of the heat exchanger and recycled to an inlet of the heat exchanger. In some embodiments, the pipeline has an inner surface roughness less than about 1000 micro-inches. In some embodiments, the method also includes pigging the pipeline with one or more bypass pigs.

In one embodiment, there is disclosed a method for maintaining production flow in a subsea pipeline, comprising producing a hydrocarbon from at least one subsea well; transporting the hydrocarbon from the at least one subsea well to a heat exchanger; passing the hydrocarbon through the heat exchanger, in order to cool the hydrocarbon and precipitate at least one solid selected from waxes, paraffins, asphaltenes, and/or hydrates; passing the hydrocarbon through a pipeline from the heat exchanger to a host; and pigging the heat exchanger with a pig to produce a slurry of the solids in the hydrocarbon; wherein the pig comprises a bypass pig.

Advantageously, embodiments disclosed herein provide for a system configured to create a suitable slurry for flow through a downstream conduit or flow line. When a suitable slurry is at approximately the same temperature as the ambient deep sea-water temperature, solid deposits are less likely to form on the inner wall surfaces. Therefore, the downstream conduit and flow line may remain operational for longer periods between pigging runs. Additionally, less buildup of solid deposits results in a lower chance that a pig will become stuck in the downstream conduit or flow line. A subsea conduit, as disclosed herein, may be shorter than the downstream conduit or flow line thereby reducing the distance pigs travel. Embodiments disclosed herein provide a system to transport the production stream with fewer interruptions from a constricted cross-sectional flow area and long, high pressure pigging runs that reduce flow rate. Therefore, the embodiments disclosed herein provide a system providing higher production of hydrocarbons.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A system for maintaining production flow in a subsea pipeline having a proximate and a distal end, the pipeline being in fluid communication with a production facility on a distal end, the system comprising:
a flow loop comprising an inlet in fluid communication with at least one subsea well adapted to receive a hydrocarbon production flow, and an outlet in fluid communication with the proximate end of the pipeline;
a pig launching system, adapted so that a pig may be selectively placed into the flow loop inlet; and
a pig receiving system, adapted so that a pig may be removed from the hydrocarbon production flow from the flow loop outlet;
wherein the flow loop has an inner surface roughness less than about 1000 micro-inches.

2. The system of claim 1, further comprising a bypass pig within the flow loop.

3. The system of claim 1, wherein the flow loop is exposed to a subsea environment to provide for cooling of the hydrocarbon production flow approaching a temperature of the subsea environment.

4. The system of claim 1, further including a bypass fluid conduit between the flow loop inlet and the proximate end of the pipeline.

5. The system of claim 1, wherein the flow loop comprises a forced coolant pipe-in-pipe system, having inner and outer pipes, adapted so that production flows through the inner pipe and coolant flows through the annulus formed between the inner and outer pipes in a direction counter to the production flow direction.

6. The system of claim 5, wherein the coolant is seawater.

7. The system of claim 1, wherein the pipeline has an inner surface roughness less than about 1000 micro-inches.

8. The system of claim 1, wherein the pipeline further comprises one or more bypass pigs.

9. A method for maintaining production flow in a subsea pipeline, comprising:
producing a hydrocarbon from at least one subsea well;
transporting the hydrocarbon from the at least one subsea well to a heat exchanger;
passing the hydrocarbon through the heat exchanger, in order to cool the hydrocarbon and precipitate at least one solid selected from waxes, paraffins, asphaltenes, and/or hydrates;
passing the hydrocarbon through a pipeline from the heat exchanger to a host; and
pigging the heat exchanger with a pig to produce a slurry of the solids in the hydrocarbon;
wherein the heat exchanger comprises a pipe having an inner surface roughness less than about 1000 micro-inches.

10. The method of claim 9, wherein the pig comprises a bypass pig.

11. The method of claim 9, wherein the pig is recovered from an outlet of the heat exchanger and recycled to an inlet of the heat exchanger.

12. The method of claim 9, wherein the pipeline has an inner surface roughness less than about 1000 micro-inches.

13. The method of claim 9, further comprising pigging the pipeline with one or more bypass pigs.

14. A method for maintaining production flow in a subsea pipeline, comprising:
producing a hydrocarbon from at least one subsea well;
transporting the hydrocarbon from the at least one subsea well to a heat exchanger;
passing the hydrocarbon through the heat exchanger, in order to cool the hydrocarbon and precipitate at least one solid selected from waxes, paraffins, asphaltenes, and/or hydrates;
passing the hydrocarbon through a pipeline from the heat exchanger to a host; and
pigging the heat exchanger with a pig to produce a slurry of the solids in the hydrocarbon;
wherein the pig comprises a bypass pig.
